(19) United States
(12) Patent Application Publication
(10) Pub. No.: US 2010/0082749 A1
(43) Pub. Date: Apr. 1, 2010

(54) RETROSPECTIVE SPAM FILTERING

(75) Inventors: Stanley WEI, Palo Alto, CA (US); Anirban KUNDU, San Francisco, CA (US); Mark RISHER, San Francisco, CA (US); Vishwanath Tumkur RAMARAO, Sunnyvale, CA (US)

Correspondence Address: Weaver Austin Villeneuve & Sampson - Yahoo!, P.O. BOX 70250, OAKLAND, CA, 94612-0250, US

(73) Assignee: YAHOO! INC, Sunnyvale, CA (US)

(21) Appl. No.: 12/239,530

(22) Filed: Sep. 26, 2008

(51) Int. Cl. G06F 15/16

(52) U.S. Cl. 709/206

(57) ABSTRACT

A mail system and mail delivery method wherein messages are tracked even after delivery and can be removed from a spam folder post delivery. In a disclosed embodiment mail features indicative of spam or normal email are analyzed and appended to the message header, which is later examined and used to move a reclassified message. False negative and false positive classification can be rectified.

### BACKGROUND OF THE INVENTION

This invention relates generally to email, and more specifically to minimizing the amount of spam received by a user.

More than 75% of all email traffic on the internet is spam. To date, spam-blocking efforts have taken two main approaches: (1) content-based filtering and (2) IP-based blacklisting. Both of these techniques are losing their potency as spammers become more agile. Spammers evade IP-based blacklists with nimble use of the IP address space such as stealing IP addresses on the same local network. Dynamically assigned IP addresses together with virtually untraceable URL's make it increasingly more difficult to limit spam traffic. For example, services such as www.tinyurl.com take an input URL and create multiple alias URL's by hashing the input URL. The generated hash URL's all take a user back to the original site specified by the input URL. When a hashed URL is used to create an email or other account, it is very difficult to trace back as numerous hash functions can be used to create a diverse selection of URL's on the fly.

To make matters worse, as most spam is now being launched by bots, spammers can send a large volume of spam in aggregate while only sending a small volume of spam to any single domain from a given IP address. The “low” and “slow” spam sending pattern and the ease with which spammers can quickly change the IP addresses from which they are sending spam has rendered today's methods of blacklisting spamming IP addresses less effective than they once were.

### SUMMARY OF THE INVENTION

A mail system and mail delivery method wherein messages are tracked even after delivery and can be removed from a spam folder post delivery. In a disclosed embodiment mail features indicative of spam or normal email are analyzed and appended to the message header, which is later examined and used to move a reclassified message. False negative and false positive classification can be rectified.

In one embodiment, a computer-implemented method for minimizing spam messages present in a user's inbox is disclosed. The method comprises: analyzing features of an incoming email message; extracting select of the analyzed features of the incoming email message; appending indications of the select analyzed features to a header of the incoming email message; delivering the incoming message to the user's inbox; extracting the indications of the appended features from the header of one or more instances of the incoming email message; determining, after delivery of the email message to the user's inbox that the email is a spam message; and removing the spam message from the inbox, after said delivery to the inbox.

Another aspect relates to a computer-implemented method for minimizing spam messages present in a user's inbox that comprises: classifying an email message as a spam message; associating a positive indication of the classification as spam with the classified message; delivering the spam message to a spam folder; evaluating post delivery information relating to the delivered spam message; determining that the positive indication associated with the delivered spam message was incorrectly specified, and rectifying the false positive indication by moving the message to the user's inbox.

A further understanding of the nature and advantages of the present invention may be realized by reference to the remaining portions of the specification and the drawings.

### BRIEF DESCRIPTION OF THE DRAWINGS

FIG. 1A illustrates a flow chart of a process according to an embodiment of the invention.

FIG. 1B is timeline of events according to an embodiment of the invention.

FIG. 2 illustrates a flow chart of a process according to an embodiment of the invention.

FIG. 3 illustrates a flow chart of a process according to another embodiment of the invention.

FIG. 4A is a simplified diagram of a computing environment in which embodiments of the invention may be implemented.

FIG. 4B is a diagram mail flow and certain components in which embodiments of the invention may be implemented.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

More than 75% of all email traffic on the internet is spam. To date, spam-blocking efforts have taken two main approaches: (1) content-based filtering and (2) IP-based blacklisting. Both of these techniques are losing their potency as spammers become more agile. Spammers evade IP-based blacklists with nimble use of the IP address space such as stealing IP addresses on the same local network. To make matters worse, as most spam is now being launched by bots, spammers can send a large volume of spam in the aggregate while only sending a small volume of spam to any single domain from a given IP address. The “low” and “slow” spam sending pattern and the ease with which spammers can quickly change the IP addresses from which they are sending spam has rendered today's methods of blacklisting spamming IP addresses less effective than they once were.

Two characteristics make it difficult for conventional blacklists to keep pace with spammers' dynamism. Firstly, existing classification is based on non-persistent identifiers. An IP address doesn't suffice as a persistent identifier for a host: many hosts obtain IP addresses from dynamic address pools, which can cause aliasing both of hosts and of IP addresses. Malicious hosts can steal IP addresses and still complete TCP connections, allowing spammers another layer of dynamism. Secondly, information about email-sending behavior is compartmentalized by limited features such as volume and spam-and-non-spam ratio. Today, a large fraction of spam comes from botnets, large groups of compromised machines controlled by a single entity. With a much larger group of machines at their disposal, spammers now disperse their jobs so that each IP address sends spam at a low rate to any single domain. By doing so, spammers can remain below the radar, since no single domain may deem any single spamming IP address as suspicious.

Users of online mail services access their email from time to time. Mail is delivered to the user's inbox and continues to accumulate before the user returns to check the message.

The interval between inbox checks can therefore be utilized to eliminate spam messages even after they have been delivered. This is useful because while it may not be known that a message is spam at the time it is delivered, it may become known that the message is spam in the interval between delivery and reading. Removing a spam message before it is read relieves the user from an ever increasing volume of spam and provides a better user experience.

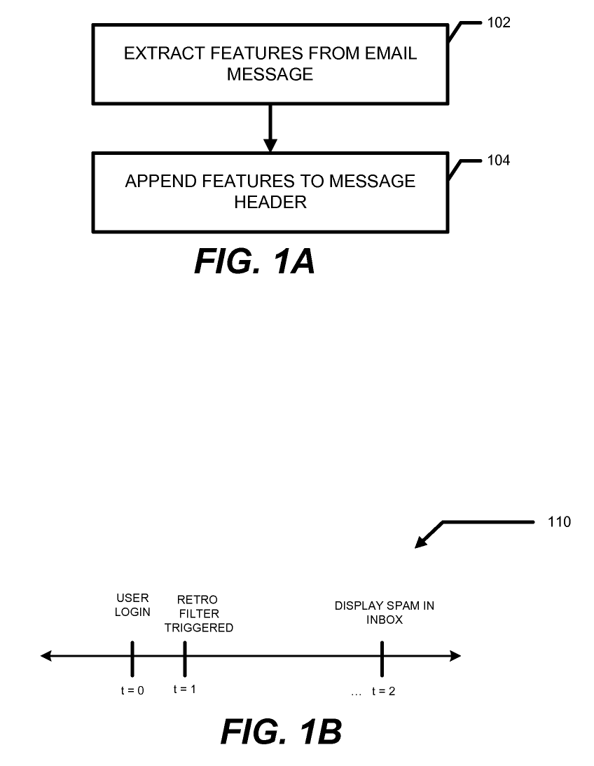

Embodiments of the present invention provide less spam to a user by applying retrospective filtering in the post delivery phase, in addition to traditional spam filtering. In a preferred embodiment, the post delivery phase retrospective filtering may be set to leave in a spam message if removing the spam message from the inbox is undesirable. For example, if a user has logged in and/or accessed his inbox after the spam message was delivered to the inbox, the spam message will be left in the inbox so as to avoid the impression that mail is disappearing from the inbox. Even if the user has not read the message or has no intention of reading the message, once the user has noticed its presence, it may be disconcerting if it seemingly “disappears” from the inbox. Thus, in certain embodiments, retrospective spam removal may be configured to leave spam in the inbox. This is represented by timeline 110 of FIG. 1B. When user login occurs at time t=0, and the retrospective filter is triggered at time t=1, and determines that an email message in a user's inbox is spam, the mail will be displayed with other messages in the inbox at time t=2. Again, this is done to avoid the impression that mail is disappearing from the inbox after the user has already logged in and seen it in his email inbox.

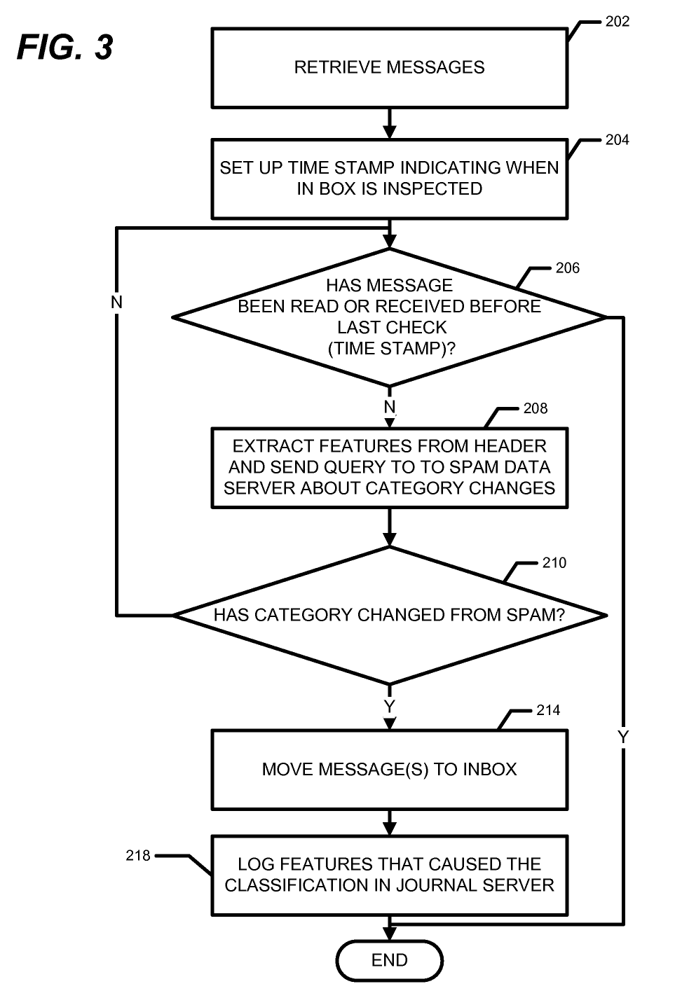

This removal of false negative (spam) messages to the spam folders is complemented by the ability to move false positive (spam) messages back to the inbox, which will be described in more detail in FIGS. 3A and 3B, respectively.

This retrospective tagging and movement, in one embodiment, entails extracting features from email messages and appending them (or representation/indications of them) in the headers of the messages, as seen in FIG. 1A. In step 102 of FIG. 1A features of incoming email messages are extracted from the messages. The extracted features comprise information related to: time series features; geographic features; sending features; and content features. More detail on the features and spam detection can be found in co-pending application Ser. No. ______, filed concurrently with the present application, attorney docket number YAH1P180, entitled “CLASSIFICATION AND CLUSTER ANALYSIS SPAM DETECTION AND REDUCTION,” which is hereby incorporated by reference in the entirety. In step 104, an indication of each feature of interest is appended to the header of each incoming message. In this way, the message header can later be read, and the feature indications analyzed to determine if a message appears to be spam or not, as will be discussed in more detail later.

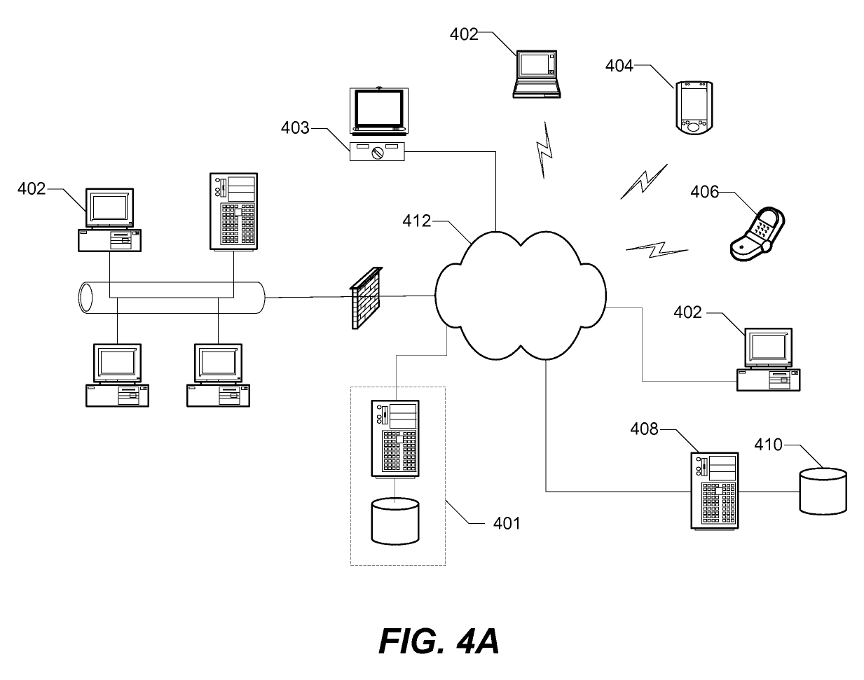

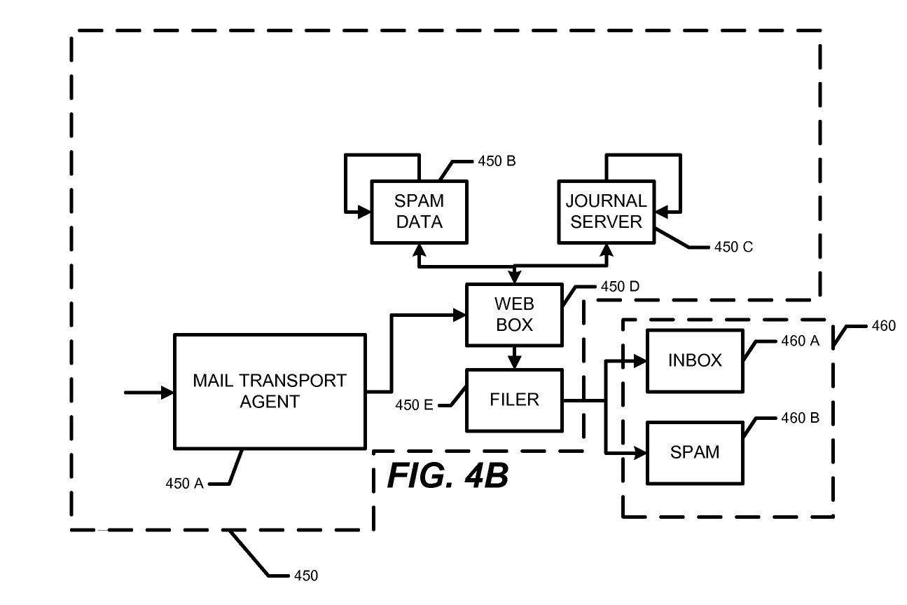

Turning now to FIG. 4B, mail flow will be explained in light of an embodiment of a mail system. A mail server system 450 comprises components 450A-E. Components 450A-E may be implemented in one or more computers and may be centrally located or geographically distributed. A user computer (client) mail system 460 comprises an inbox 460A and spam folder 460B. Mail transport agent 450A transports mail to a multitude of email users via a web box 450D. Web box 450D is a server that handles user requests, front end rendering, and data retrieval from the back end. When users try to login their email accounts, it is through web box 450D. Spam data server 450B keeps track of spam mail and the features that indicate what features are found in spam and what emails are designated as spam. Journal server 450C similarly tracks “normal” emails not designated as spam, and is referenced for false positive tracking purposes. In a preferred embodiment, spam data server 450B and journal server 450C are implemented in a memory cache (“memcache”) server so as to be readily available with a minimum delay. Filer 450A serves as storage for the multitude of users' email message. Mail from filer 450E is designated either as to be delivered to and presented in inbox 460A or Spam folder 460B.

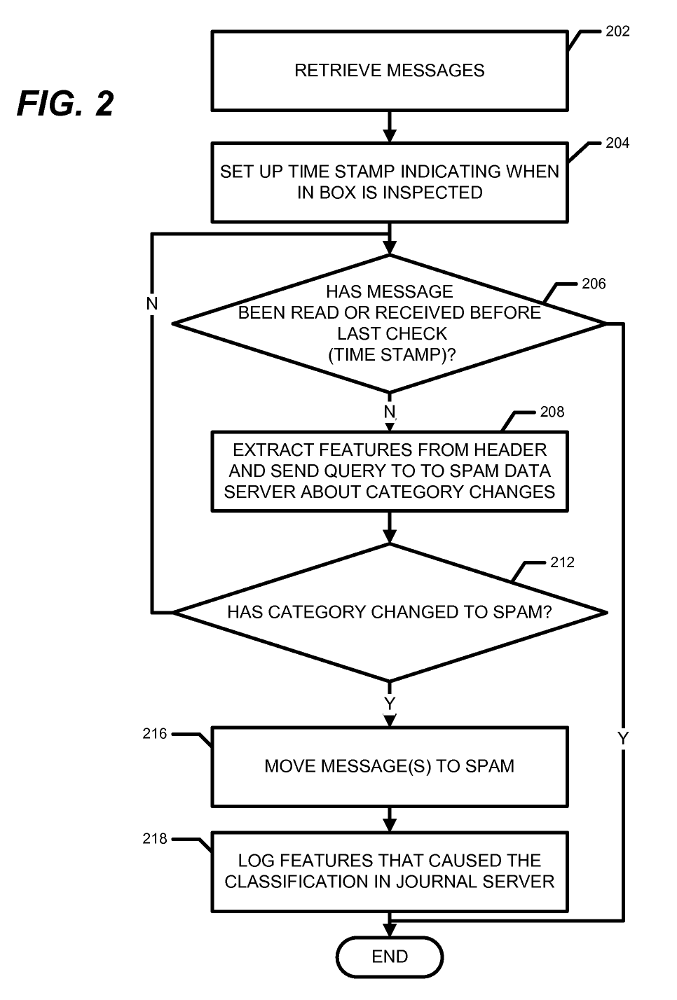

FIG. 2, in conjunction with FIG. 1A illustrates spam recognition and mail delivery. Turning now to FIG. 2, in step 202, a user, and system 450 retrieves a user's email messages. The messages are sorted by a timestamp of when they were received. In step 204, the system records a time stamp of when the user last logged in and inspected his inbox. Next, in step 206 each new message to be retrieved is checked to see if it has been read or received before the last check by comparing the time stamps of steps 202 and 204. If the message was read or received in step 206, the message will be displayed regardless of whether it is currently known or thought to be spam. If, however it has not been read or received, the system will extract the appended features from the header and send a query to the spam data server about category changes, in step 208. If it is determined that the category of the messages has changed to spam in step 212, the spam message will be moved to the spam folder in step 216. In step 218, the system will log the features that caused the category or classification change in the journal server.

FIG. 3 illustrates moving a message that has retrospectively been determined to be falsely classified as spam after having been delivered to the spam folder. Steps previously described with regard to FIG. 2 will not be discussed again. In step 210, the system will check to see if the category of a message in the spam folder has changed so that it is no longer designated as spam. If it is so determined in step 210, the message will be moved to the inbox in step 214, and in step 218 the features that caused the classification change will be logged to the journal server.

Such an email system may be implemented as part of a larger network, for example, as illustrated in the diagram of FIG. 4. Implementations are contemplated in which a population of users interacts with a diverse network environment, accesses email and uses search services, via any type of computer (e.g., desktop, laptop, tablet, etc.) 402, media computing platforms 403 (e.g., cable and satellite set top boxes and digital video recorders), mobile computing devices (e.g., PDAs) 404, cell phones 406, or any other type of computing or communication platform. The population of users might include, for example, users of online email and search services such as those provided by Yahoo! Inc. (represented by computing device and associated data store 401).

Regardless of the nature of the email service provider, email may be processed in accordance with an embodiment of the invention in some centralized manner. This was discussed previously with regard to FIG. 4B and is represented in FIG. 4A by server 408 and data store 410 which, as will be understood, may correspond to multiple distributed devices and data stores. The invention may also be practiced in a wide variety of network environments including, for example, TCP/IP-based networks, telecommunications networks, wireless networks, public networks, private networks, various combinations of these, etc. Such networks, as well as the potentially distributed nature of some implementations, are represented by network 412.

In addition, the computer program instructions with which embodiments of the invention are implemented may be stored in any type of tangible computer-readable media, and may be executed according to a variety of computing models including a client/server model, a peer-to-peer model, on a stand-alone computing device, or according to a distributed computing model in which various of the functionalities described herein may be effected or employed at different locations.

The above described embodiments have several advantages. They are adaptive and can dynamically track the algorithmic improvements made by spammers, even if detection comes after the initial categorization and delivery of the email. This is especially advantageous if the email traffic and behavior of a large population of users can be analyzed. For example, even if the features of the email do not initially positively trigger a spam classification, features can in time change due to user classification or usage patterns. With a login (web, phone etc.) based mail interface, spam can be removed in the period after delivery but pre-login. This can also be implemented in other direct delivery or pop email access scenarios to remove spam messages from whatever folders they may be stored in.

While the invention has been particularly shown and described with reference to specific embodiments thereof, it will be understood by those skilled in the art that changes in the form and details of the disclosed embodiments may be made without departing from the spirit or scope of the invention

In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for minimizing spam messages present in a user's inbox, comprising:
analyzing features of an incoming email message;
extracting select of the analyzed features of the incoming email message;
appending indications of the select analyzed features to a header of the incoming email message;
delivering the incoming message to the user's inbox;
extracting the indications of the appended features from the header of one or more instances of the incoming email message;
determining, after delivery of the email message to the user's inbox that the email is a spam message;
and removing the spam message from the inbox, after said delivery to the inbox.

2. The method of claim 1, wherein analyzing the features comprises analyzing:
an originating IP address of the message;
an originating URL of the message; and
content of the message.

3. The method of claim 1, wherein determining after delivery that the email is a spam message comprises monitoring whether other users who have received the same email in their inbox do not open the message within a threshold period of time.

4. The method of claim 1, wherein determining after delivery that the email is a spam message comprises analyzing a vector comprising data related to:
time series features;
geographic features;
sending features; and
content features.

5. The method of claim 1, further comprising storing a time stamp of user login or inspection of the inbox.

6. The method of claim 5, further comprising referencing the stored time stamp and determining whether a message was delivered prior to the last user login or inspection of the inbox, prior to removing the spam message from the inbox.

7. The method of claim 6, wherein the spam message is removed from the inbox only if it was delivered prior to the last user login or inspection of the inbox.

8. A computer-implemented method for minimizing spam messages present in a user's inbox, comprising:
classifying an email message as a spam message;
associating a positive indication of the classification as spam with the classified message;
delivering the spam message to a spam folder;
evaluating post delivery information relating to the delivered spam message;
determining that the positive indication associated with the delivered spam message was incorrectly specified, and rectifying the false positive indication by moving the message to the user's inbox.

9. The method of claim 8, wherein the positive indication is stored in a memory cache server of a mail provider.

10. The method of claim 8, further comprising:
analyzing features of the email message;
extracting indications of select of the analyzed features of the email message;
appending indications of the select analyzed features to a header of the incoming email message.

11. A computer-implemented method for minimizing spam messages present in a user's inbox, comprising:
associating a negative indication of the classification as spam with an incoming email message;
delivering the email message to the user's inbox;
evaluating post delivery information relating to the delivered message;
determining that the negative indication associated with the delivered message was incorrectly specified, and rectifying the false negative indication by moving the message to a spam folder.

12. The method of claim 11, wherein the negative indication is stored in a memory cache server of a mail provider.

13. A computer system for providing email to a group of users, the computer system configured to:
analyze features of an incoming email message;
extracting select of the analyzed features of the incoming email message;
append indications of the select analyzed features to a header of the incoming email message;
deliver the incoming message to a user's inbox;
extract the appended feature indications from the header of one or more instances of the incoming email message;
determine, after delivery of the email message to the user's inbox that the email is a spam message;
and remove the spam message from the inbox, after said delivery to the inbox.
